(19) United States
(12) Patent Application Publication
(10) Pub. No.: US 2022/0215260 A1
(43) Pub. Date: Jul. 7, 2022

(54) NODE DISAMBIGUATION

(71) Applicant: HUAWEI TECHNOLOGIES CO., LTD., Shenzhen (CN)

(72) Inventors: George DASOULAS, Boulogne Billancourt (FR); Ludovic DOS SANTOS, Boulogne Billancourt (FR); Kevin SCAMAN, Boulogne Billancourt (FR); Aladin VIRMAUX, Boulogne Billancourt (FR)

(73) Assignee: HUAWEI TECHNOLOGIES CO., LTD., Shenzhen (CN)

(21) Appl. No.: 17/702,064

(22) Filed: Mar. 23, 2022

Related U.S. Application Data
(63) Continuation of application No. PCT/EP2019/075796, filed on Sep. 25, 2019.

(51) Int. Cl. G06N 3/08; G06N 3/04; G06K 9/62

(52) U.S. Cl. CPC G06N 3/08; G06K 9/6296; G06K 9/6256; G06N 3/0481

(57) ABSTRACT

A data processing system for implementing a machine learning process in dependence on a graph neural network, the system being configured to receive a plurality of input graphs each having a plurality of nodes, at least some of the nodes having an attribute, the system being configured to: for at least one graph of the input graphs: determine one or more sets of nodes of the plurality of nodes, the nodes of each set having identical attributes; for each set, assign a label to each of the nodes of that set so that each node of a set has a different label from the other nodes of that set; process the sets to form an aggregate value; and implement the machine learning process taking as input: (i) the input graphs with the exception of the said sets and (ii) the aggregate value.

### CROSS-REFERENCE TO RELATED APPLICATIONS

This application is a continuation of International Application No. PCT/EP2019/075796, filed on Sep. 25, 2019. The disclosure of the aforementioned application is hereby incorporated by reference in its entirety.

### FIELD OF THE INVENTION

This invention relates to graph neural networks, in particular to the disambiguation of nodes with identical attributes in such networks.

### BACKGROUND

The ability to learn accurate representations is seen by many machine learning researchers as the main reason behind the tremendous success of the field in recent years. In areas such as image analysis, natural language processing and reinforcement learning, ground-breaking results rely on efficient and flexible deep learning architectures that are capable of transforming a complex input into a simple vector, whilst retaining most of its valuable features.

Graph representation tackles the problem of mapping high dimensional objects to simple vectors through local aggregation steps in order to perform machine learning tasks such as regression or classification.

Some works investigating the use of neural networks for graphs use recurrent neural networks to represent directed acyclic graphs, for example as described in Alessandro Sperduti and Antonina Starita, “Supervised neural networks for the classification of structures”, IEEE Transactions on Neural Networks, 8(3):714-735, 1997 and Paolo Frasconi, Marco Gori and Alessandro Sperduti, “A general framework for adaptive processing of data structures”, IEEE transactions on Neural Networks, 9(5):768-786, 1998.

More generic graph neural networks are described in Marco Gori, Gabriele Monfardini and Franco Scarselli, “A new model for learning in graph domains”, Proceedings of the IEEE International Joint Conference on Neural Networks, 2005, volume 2, pages 729-734. IEEE, 2005 and Franco Scarselli, Marco Gori, Ah Chung Tsoi, Markus Hagenbuchner and Gabriele Monfardini, “The graph neural network model”, IEEE Transactions on Neural Networks, 20(1):61-80, 2009.

Such generic approaches may generally be divided into two categories. Firstly, spectral methods, as described in Joan Bruna, Wojciech Zaremba, Arthur Szlam and Yann Lecun, “Spectral networks and locally connected networks on graphs”, ICLR, 2014, and Mikael Henaff, Joan Bruna and Yann LeCun, “Deep convolutional networks on graph-structured data”, arXiv preprint arXiv:1506.05163, 2015. These methods perform convolution on the Fourier domain of the graph through the spectral decomposition of the graph Laplacian. However, these methods suffer from a lack of spatial localisation and high computational complexity. The second category comprises methods that are based on the aggregation of neighbourhood information through a local iterative process. For example, message passing neural networks (MPNN), as described in Justin Gilmer, Samuel S Schoenholz, Patrick F Riley, Oriol Vinyals and George E Dahl, “Neural message passing for quantum chemistry”, ICML, 2017, or neighbourhood aggregation schemes, as described in Keyulu Xu, Weihua Hu, Jure Leskovec and Stefanie Jegelka, “How powerful are graph neural networks?”, ICLR, 2019.

This second category contains most state-of-the-art graph representation methods, including DeepWalk (as described in Bryan Perozzi, Rami Al-Rfou and Steven Skiena, “Deepwalk: Online learning of social representations”, Proceedings of the 20th ACM SIGKDD international conference on knowledge discovery and data mining, pages 701-710. ACM, 2014), graph attention networks (GAT) (as described in Petar Velickovic, Guillem Cucurull, Arantxa Casanova, Adriana Romero, Pietro Lio and Yoshua Bengio, “Graph attention networks”, ICLR, 2018) or graphSAGE (as described in Will Hamilton, Zhitao Ying and Jure Leskovec, “Inductive representation learning on large graphs”, Advances in Neural Information Processing Systems, pages 1024-1034, 2017).

However, these procedures may suffer from a loss of performance (for example, classification accuracy, regression loss or more generally any quality metric of a machine learning task) due to the similarity of node attributes that makes them hard to distinguish by the neural network.

Therefore, despite their practical efficiency and strong relationship with the Weisfeiler-Lehman test for graph isomorphism, techniques such as message passing neural networks may be incapable of distinguishing simple graph structures and may thus not be sufficiently expressive to provide good performance on any graph machine learning task.

It is desirable to be able to disambiguate nodes in graph neural networks to allow them to be accurately applied to any machine learning task.

### SUMMARY OF THE INVENTION

According to a first aspect there is provided a data processing system for implementing a machine learning process in dependence on a graph neural network, the system being configured to receive a plurality of input graphs each having a plurality of nodes, at least some of the nodes having an attribute, the system being configured to: for at least one graph of the input graphs: determine one or more sets of nodes of the plurality of nodes, the nodes of each set having identical attributes; for each set, assign a label to each of the nodes of that set so that each node of a set has a different label from the other nodes of that set; process the sets to form an aggregate value and/or an aggregate value for each set; and implement the machine learning process taking as input: (i) the input graphs with the exception of the said sets and (ii) the aggregate value and/or the aggregate value for each set.

The system provides a way to differentiate objects with the same attributes in the context of structured data in a universal graph representation. The use of labels efficiently separates nodes with the same attributes in a graph neural network. Disambiguation of nodes using this scheme allows for the separation of non-isomorphic graphs and allows the neural network to better identify each node and perform targeted computation.

The system may be configured to process each set to form an aggregate value by processing neighbour nodes of each node of that set using a permutation invariant function. This may allow for the aggregation of information from both the node itself and its neighbourhood.

The permutation invariant function may be one of a sum, a mean, or a maximum. Other convenient functions may be used.

The system may be configured to process the sets by assigning weights to the nodes, wherein the weights are the parameters of a neural network. This may allow a set of optimal weights to be learned by the network.

The system may be further configured to iteratively update the weights. This may improve the accuracy.

Each attribute and/or label may be a vector. Each label may be an additional attribute. Each label may be a colour. Colours may be represented as one-hot encodings vectors or more generally as any finite set of k elements. The use of colours as labels may efficiently separate nodes with the same attributes in a graph neural network.

The labels may be randomly assigned to the determined nodes. This may be an efficient way of assigning labels to the nodes.

According to a second aspect there is provided a method for implementing a machine learning process in dependence on a graph neural network in a data processing system, the system being configured to receive a plurality of input graphs each having a plurality of nodes, at least some of the nodes having an attribute, the method comprising: for at least one graph of the input graphs: determining one or more sets of nodes of the plurality of nodes, the nodes of each set having identical attributes; for each set, assigning a label to each of the nodes of that set so that each node of a set has a different label from the other nodes of that set; processing the sets to form an aggregate value and/or an aggregate value for each set; and implementing the machine learning process taking as input: (i) the input graphs with the exception of the said sets and (ii) the aggregate value and/or the aggregate value for each set.

The method provides a way to differentiate objects with the same attributes in the context of structured data in a universal graph representation. The use of labels efficiently separates nodes with the same attributes in a graph neural network. Disambiguation of nodes using this scheme allows for the separation of non-isomorphic graphs and allows the neural network to better identify each node and perform targeted computation.

Each set may be processed to form an aggregate value by processing neighbour nodes of each node of that set using a permutation invariant function. This may allow for the aggregation of information from both the node itself and its neighbourhood.

The permutation invariant function may be one of a sum, a mean, or a maximum. Other convenient functions may be used.

The method may further comprise processing the sets by assigning weights to the nodes, wherein the weights are the parameters of a neural network. This may allow a set of optimal weights to be learned by the network.

The method may further comprise iteratively updating the weights. This may improve the accuracy.

Each label may be a colour. Colours may be represented as one-hot encodings vectors or more generally as any finite set of k elements. The use of colours as labels may efficiently separate nodes with the same attributes in a graph neural network.

The labels may be randomly assigned to the determined nodes. This may be an efficient way of assigning labels to the nodes.

According to a third aspect there is provided a computer program which, when executed by a computer, causes the computer to perform the method described above. The computer program may be provided on a non-transitory computer readable storage medium.

### BRIEF DESCRIPTION OF THE FIGURES

The present invention will now be described by way of example with reference to the accompanying drawings. In the drawings:

FIG. 1 shows an overview of a data processing system which assigns labels to identical node attributes to disambiguate them.

FIG. 2 shows an example of an iterative method using colourings to differentiate identical nodes.

FIG. 3 illustrates the concatenation of a node's attribute with the colour it was assigned.

FIGS. 4 and 5 illustrate the application of the technique to a malware classification task.

FIG. 6 illustrates a method for implementing a machine learning process in dependence on a graph neural network in a data processing system.

FIG. 7 shows an example of a data processing system.

FIG. 8 shows results from the use of the approach on three synthetic datasets to distinguish structural graph properties.

FIG. 9 shows results from use of the approach on five real-world graph classification datasets extracted from standard social networks (IMDBb and IMDBm) and bio-informatics databases (MUTAG, PROTEINS and PTC).

### DETAILED DESCRIPTION OF THE INVENTION

The present invention proposes a technical solution to the problem of node ambiguity in graph neural networks. The system described herein can learn a representation of structured data in order to perform machine learning (ML) tasks using this data. The system computes a disambiguation scheme in order to efficiently separate identical node attributes before applying any machine learning algorithm.

A definition for graphs with node attributes will now be described. Consider a dataset of n interacting objects (for example, users of a social network) in which each object i ∈ [symbol] 1,n [symbol] has a vector attribute vᵢ ∈ [symbol] ^{m} and is a node in an undirected graph G with adjacency matrix A ∈ [symbol] ^{n×n}.

The space of graphs of size n with m-dimensional node attributes is defined by the quotient space:

Graph_{m,n}={(v,A)∈ [symbol] ^{n×m}× [symbol] ^{n×n}}/ [symbol] (1)

where A is the adjacency matrix of the graph, v contains the m-dimensional representation of each node in the graph and the set of permutations matrices [symbol] is acting on (v, A) by:

∀P ∈ [symbol] ₙ, P·(v,A)=(Pv, P AP^{T}) (2)

In the case where the graphs have a maximum size nₘₐₓ, where nₘₐₓ, is a large integer, this allows for consideration of functions on graphs of different sizes without obtaining infinite dimensional spaces and infinitely complex functions that would be impossible to learn via a finite number of samples. Thus Graphₘ is defined as:

Graphₘ=U_{n≤n}_{ₘₐₓ}Graph_{m,n} (3)

The system described herein utilizes a general machine learning pipeline to deal with structured data in graphs, a labelling scheme to separate nodes with identical attributes, and a method to combine outputs from all labelled graphs and return a single output. This procedure is able to capture more complex structural graph characteristics than traditional MPNNs.

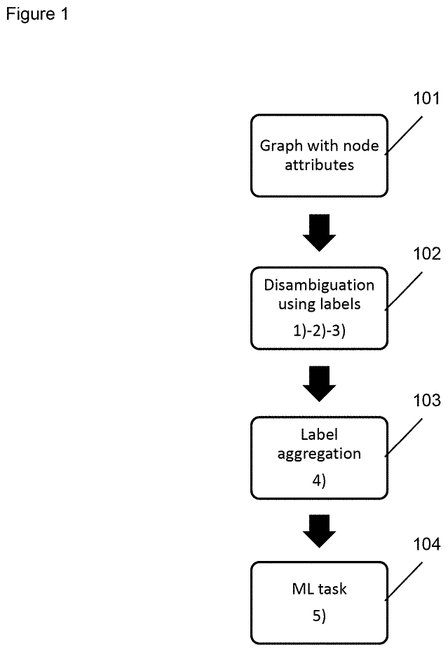

As illustrated in the overview of FIG. 1, the system assigns labels to identical node attributes to disambiguate them. An attribute may be any quality, feature or characteristic of a node. As shown at 101, identical node attributes are first identified. At 102, a different label (preferably represented as a vector) is appended to each node in a set of identical nodes so that all (attribute, label) pairs are different. Then, as shown at 103, an aggregation scheme is used to gather all labelled graphs and return a single output value that can be used for the considered ML task at 104.

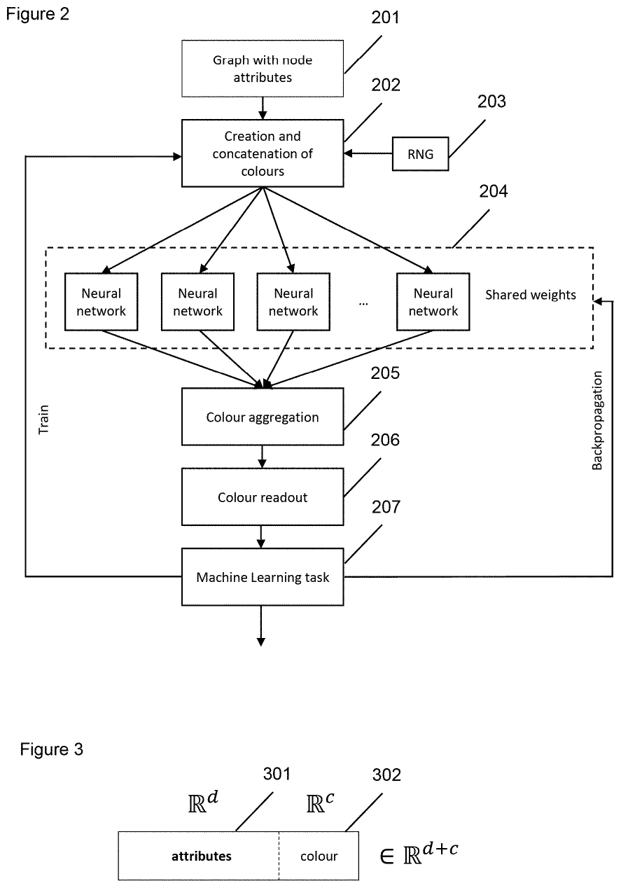

In one embodiment, a procedure is used which uses colours as the labels to differentiate identical node attributes in order to distinguish non-isomorphic graphs. The steps of this preferred implementation are illustrated in more detail in FIG. 2.

The iterative method comprises the following steps. The graphs with node attributes are provided at 201. At step 202, the system first clusters the nodes of the graph into sets of nodes having identical node attributes. Then, for each set, the system generates a fixed number of colourings, each colouring being the attribution of a random colour to each node in the set. A random number generator is shown at 203 for randomly assigning colours to each node. For each colouring, each node concatenates its attribute with the colour it was assigned. The colourings are preferably randomly assigned to the nodes. The colour concatenation is illustrated in FIG. 3. A graph with node attributes 301 augmented using colours 302 is referred to herein as a coloured graph. Then, each coloured graph is processed using the same neural network, shown at 204, comprising several iterations of aggregation of neighbours' coloured attributes. At 205 and 206, the final output is obtained by aggregating all of the outputs of the neural networks for all coloured graphs using a permutation invariant function (such as a maximum or sum). The model is trained through a gradient descent-based optimization algorithm and backpropagation is performed on the output of the method to learn the neural network weights and best graph representation for the considered ML task, shown at 207.

More precisely, consider a set V of n nodes and a graph G=(V, E) together with a feature vector vᵢ ∈ [symbol] ^{m} for every node. Let d>. The present method computes a projection on the graph vᵢ→xᵢ ∈ [symbol] ^{d} in such a way that important relations regarding a ML task are preserved.

The global workflow can be represented by the following:

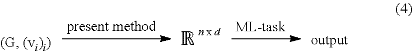

The method aims to learn neural network weights in order to compute a vector representation of a graph. The labelling method does not depend on the weights or on the structure of the neural network, but disambiguates a node's representation by concatenating a label to its features. The weights can be learnt using any gradient descent-based optimization algorithm until a sufficiently accurate model is arrived at for the specific assigned ML task.

The mathematical formulations of each step of the method will now being described for the case where the label is a colour.

In the colour generation/feature augmentation stage, for any k ∈ [symbol] , let Cₖ be a set of k colours. This set of k distinct colourings are preferably selected uniformly at random. These colours may be represented as one-hot encodings vectors (Cₖ is the natural basis of [symbol] ^{k}) or more generally as any finite set of k elements.

Nodes with identical attributes are grouped into the partition V₁, . . . , V_{K}⊂ [symbol] 1, n [symbol] . Then, for a set Vₖ of size |Vₖ|, each node of the set is given a distinct colour in C_{|V}_{ₖ}_{|}. More precisely, the set of colourings [symbol] (v,A) of a graph G=(v, A) are defined as:

[symbol]

(v,A)={(c₁, . . . , cₙ): ∀k∈ [symbol] 1, K [symbol] , (cᵢ)_{i∈V}_{ₖ} is a permutation of C_{|V}_{ₖ}_{|}} (5)

Therefore, for each colouring c ∈ Cₖ, node representations are initialized with their node attributes concatenated with their colour: x_{i,0}^{c}=(vᵢ, cᵢ).

In the aggregation and combination scheme, each local aggregation step takes as input a couple (xᵢ, {xⱼ [symbol] ) where xᵢ ∈ [symbol] ^{m} is the representation of node i and {xⱼ [symbol] is the set of vector representations of the neighbours of node i.

The set of node neighbourhoods for m-dimensional node attributes is defined as:

Neighbourhoodₘ= [symbol] ^{m}×U_{n≤n}_{ₘₐₓ}( [symbol] ^{n×m}/ [symbol] ₙ) (6)

where the set of permutation matrices [symbol] ₙ is acting on [symbol] ^{n×m} by P·v=Pv.

The main difficulty in designing universal neighbourhood representations is that the node neighbourhoods as defined in Equation (6) are permutation invariant with respect to neighbouring node attributes, and hence require permutation invariant representations. The neural network as described herein is a separable permutation invariant network with a multilayer perceptron (MLP) that aggregates both information from the node itself and its neighbourhood. The network is defined as:

NN(x,S)=ψ(x, Σ_{yeS}σ(y)) (7)

where ψ and σ are MLPs with continuous non-polynomial activation functions.

In the colour aggregation stage, for all generated colourings c ∈ [symbol] (v, A) at the previous step, the augmented featured vectors (i.e. the concatenation of the attributes of the node and its corresponding colour) are aggregated using the neural network:

x_{i,t+1}^{c}=NN^{(t)}(x_{i,t,}^{c}{x_{j,t+1}^{c} [symbol] ) (8)

This function is a universal neighbourhood representation.

In the colour readout stage, from the aggregation, the transformed augmented vector is selected using a coefficient-wise permutation invariant function, such as a maximum. For example:

$${x}_{G} = ψ ( {max}_{c ∈ 𝒞 ( v , A )} {\sum }_{i = 1}^{n} {x}_{\{ i , T \}}^{c} ) \qquad ( 9 )$$

where ψ is a MLP with continuous non polynomial activation functions.

This step therefore performs a maximum (or other function) over all possible colourings in order to obtain a final colour-independent graph representation. In order to keep the stability by concatenation, the maximum is taken coefficient-wise.

The vector x_{G} is then processed by any ML algorithm and the weights of the neural network are updated using backpropagation.

As the local iterative steps are performed T times on each node and the complexity of the aggregation depends on the number of neighbours of the considered node, the complexity is proportional to the number of edges of the graph E and the number of steps T. Moreover, this iterative aggregation is performed for each colouring, and the complexity of the algorithm is also proportional to the number of chosen colourings k=|Cₖ|. Hence the complexity of the algorithm is in 0 (kET).

The approach described above may be performed by a data processing system such as a server or combination of servers or a portable device such as a cellular communications device. The system may implement a machine learning process in dependence on a graph neural network. The system may have inputs (e.g. internal inputs or network inputs) whereby it can receive a plurality of input graphs. Each graph may have a plurality of nodes and at least some of the nodes may have an attribute. Having received the graphs, the system may for at least one of the input graphs determine one or more sets of the nodes of that graph. The set may be determined such that the nodes of that set all have some or all of their attributes identical. Then for each of those sets the system may assign a label to each of their nodes. The nodes may be selected so that each node of a set has a different label from the other nodes of that set. Then the system may process the sets to form either an aggregate value for all the sets, or a series of aggregate values, one for each set. Then the system can implement a machine learning process taking as input: (i) the input graphs with the exception of the said sets and (ii) the or each of the aggregate values it has formed. This approach can simplify the processing of the graphs.

The system and method described herein are applicable in many technical fields requiring the use of data processing. For example, in the field of telecommunications, many datasets to be dealt with are structured as graphs. Some examples include process execution graphs for malware identification, handover graphs for wireless applications such as traffic prediction at the scale of single base stations, or parameter tuning of wireless base stations. Other areas in which graphs may be used include protein interactions, ego networks in social networks and user-item pairs for recommendation systems. Regression of graph characteristics can be used to, for example, learn missing information on social networks or communication networks, or for regression of temporal data in areas such as weather forecasting.

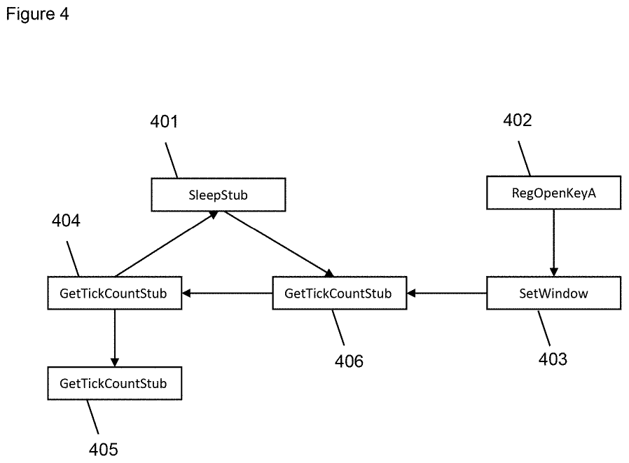

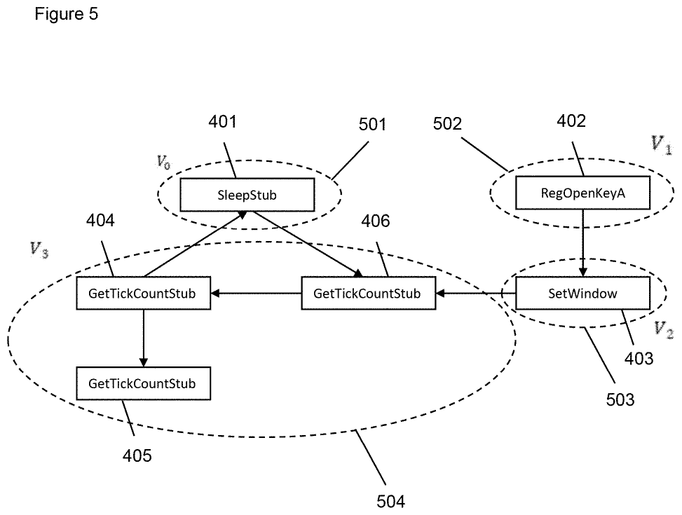

FIGS. 4 and 5 illustration the application of the technique to a malware classification task. Sequences of events are generated by a software program execution (for example, application programming interface (API) calls) and it is required to decide whether or not this software is a malware.

Such sequences of events can be formatted into an execution graph, where APIs (for this particular example) are nodes attributes, as shown in FIGS. 4 and 5. In these figures, an execution trace is formatted into an execution graph. In this case, there are six nodes 401-406. The nodes are partitioned into four groups of nodes, V₀, V₁, V₂, V₃, shown at 501, 502, 503 and 504 respectively in FIG. 5.

Since all groups but V₃ have a cardinality equal to one, in this case, colours are only sampled on the nodes 404, 405 and 406 in group V₃ using the colour generation procedure described previously. This process allows all of the nodes in V₃ to be distinguished. The general mathematical method described previously is then followed. The inputs of the model are the representations of the APIs that could be one hot encoded, or come from another algorithm (for example, word2vec representations). The method then outputs a vector which is used to learn a classifier to predict whether the software is a malware or not.

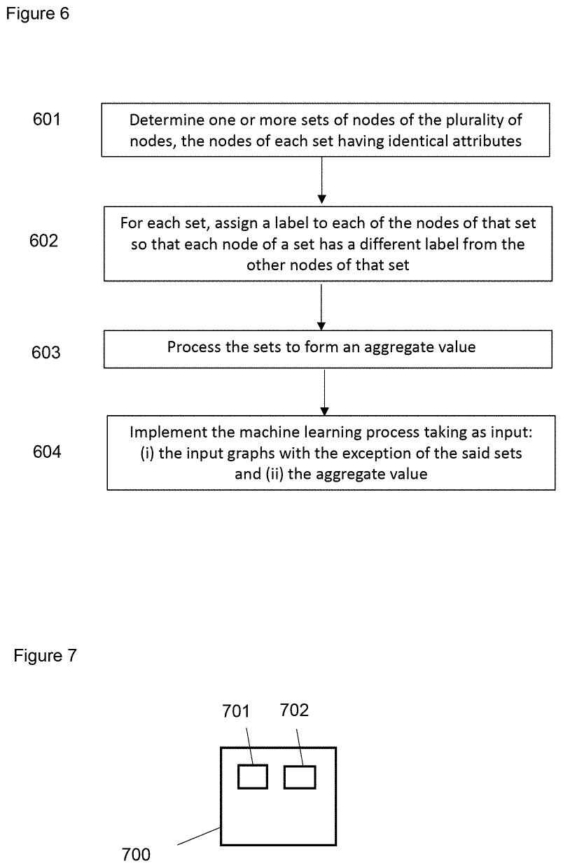

FIG. 6 summarises a method for implementing a machine learning process in dependence on a graph neural network in a data processing system, the system being configured to receive a plurality of input graphs each having a plurality of nodes, at least some of the nodes having an attribute. For at least one graph of the input graphs, the method comprises, at step 601, determining one or more sets of nodes of the plurality of nodes, the nodes of each set having identical attributes. At step 602, the method comprises, for each set, assigning a label to each of the nodes of that set so that each node of a set has a different label from the other nodes of that set. At step 603, the method comprises processing the sets to form an aggregate value. At step 604, the method comprises implementing the machine learning process taking as input: (i) the input graphs with the exception of the said sets and (ii) the aggregate value.

FIG. 7 shows a schematic diagram of a data processing system 700 configured to implement the networks described above and its associated components. The system may comprise a processor 701 and a non-volatile memory 702. The system may comprise more than one processor and more than one memory. The memory may store data that is executable by the processor. The processor may be configured to operate in accordance with a computer program stored in non-transitory form on a machine readable storage medium. The computer program may store instructions for causing the processor to perform its methods in the manner described herein. The components may be implemented in physical hardware or may be deployed on various edge or cloud devices.

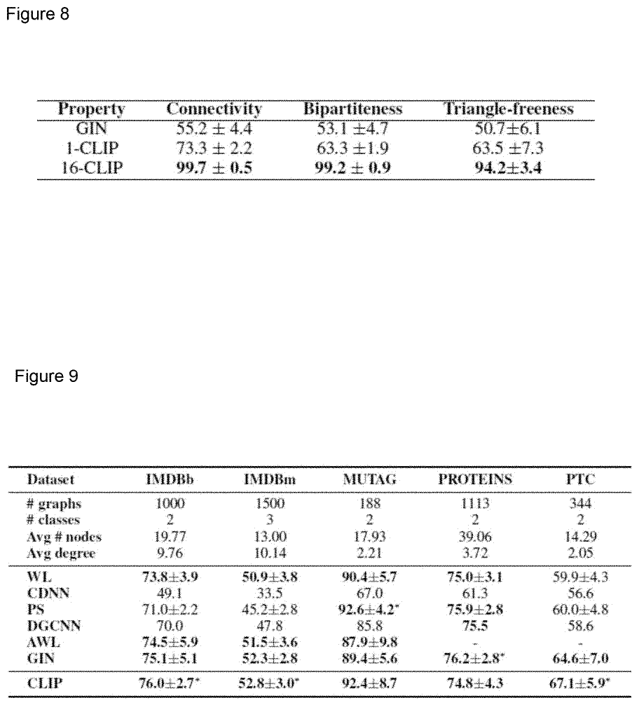

The results of two sets of experiments to compare the approach described herein with state-of-the-art methods in supervised learning settings are shown in FIGS. 8 and 9. Both experiments follow the same experimental protocol as described in Keyulu Xu, Weihua Hu, Jure Leskovec, and Stefanie Jegelka, “How powerful are graph neural networks?”, ICLR, 2019 (10-fold cross validation with grid search hyper-parameter optimization).

In FIG. 8, results are shown from the use of the present approach (CLIP) on three synthetic datasets to distinguish structural graph properties. A graph property is a set of graphs which is closed under graph isomorphism. The performance of the method was evaluated against GIN: Graph Isomorphism Network (as described in Keyulu Xu, Weihua Hu, Jure Leskovec, and Stefanie Jegelka, “How powerful are graph neural networks?”, ICLR, 2019) for the binary classification of three different structural properties: connectivity, bipartiteness and triangle-freeness.

The table in FIG. 8 shows the classification accuracies of the synthetic datasets. For k-CLIP, k>0 colourings were randomly chosen for the computation of the CLIP model. These results show that the approach described herein is in some implementations able to capture the structural information of connectivity, bipartiteness and triangle-freeness. One-hot encoding (equivalent to 1-CLIP) may improve the accuracy. Moreover, the use of a greater number of colourings may lead to better accuracy. In this implementation, high accuracies were obtained for as little as k=16 colourings.

In FIG. 9, results are shown for use of the approach on five real-world graph classification datasets extracted from standard social networks (IMDBb and IMDBm) and bio-informatics databases (MUTAG, PROTEINS and PTC). Following standard practices for graph classification on these datasets, one-hot encodings of node degrees as node attributes were used for IMDBb and IMDBm and single-label multi-class classification was performed on all datasets.

The present approach (CLIP) is shown compared with six state-of-the-art baseline algorithms: WL: Weisfeiler-Lehman subtree kernel (as described in Nino Shervashidze, Pascal Schweitzer, Erik Jan van Leeuwen, Kurt Mehlhorn, and Karsten M Borgwardt, “Weisfeiler-lehman graph kernels”, Journal of Machine Learning Research, 2011), AWL: Anonymous Walk Embeddings (as described in Sergey Ivanov and Evgeny Burnaev, “Anonymous walk embeddings”, ICML, 2018), DCNN: Diffusion-convolutional neural networks (as described in James Atwood and Don Towsley, “Diffusion-convolutional neural networks”, Advances in Neural Information Processing Systems, 2016), PS: PATCHY-SAN (as described in Mathias Niepert, Mohamed Ahmed, and Konstantin Kutzkov, “Learning convolutional neural networks for graphs”, International conference on machine learning, 2016), DGCNN: Deep Graph CNN (as described in Muhan Zhang, Zhicheng Cui, Marion Neumann, and Yixin Chen, “An end-to-end deep learning architecture for graph classification”, Proceedings of AAAI Conference on Artificial Intelligence, 2018) and GIN. WL and AWL are representative of unsupervised methods coupled with an SVM classifier, while DCNN, PS, DGCNN and GIN are four deep learning architectures.

FIG. 9 shows a table of the classification accuracies of the compared methods on benchmark datasets. The best performer with respect to the mean is highlighted with an asterisk. An unpaired t-test with asymptotic significance of 0.1 with respect to the best performer and highlight with boldface the ones for which the difference is not statistically significant.

In this implementation, the present approach (CLIP) showed the best performance for three out of the five benchmark datasets and performed comparably to its competitors on the others. For the PTC dataset, the present approach significantly outperforms its competitors, which may indicate that this classification task requires more structural information on the graphs. The high variance of most methods on MUTAG and PTC is likely due to the small number of graphs.

The present invention therefore provides a way to differentiate objects with the same attributes in the context of structured data in a universal graph representation. The use of labels efficiently separates nodes with the same attributes in a graph neural network. In practice, the approach comprises concatenating different vectors to similar nodes attributes. Disambiguation of nodes using this scheme allows for the separation of non-isomorphic graphs.

The method described herein allows the neural network to better identify each node and perform targeted computation. As illustrated by the experimental results, in some implementations the method can achieve state-of-the-art results on classical datasets and can separate any pair of non-isomorphic graphs, extract any valuable pattern from the structured data, and successfully learn any machine learning task given a sufficient amount of data. The method can compute complex structural characteristics of the graphs, such as the number of triangles or other small-scale patterns, which may be important for the considered machine learning task.

The approach is applicable to data structures such as directed or weighted graphs with node attributes, graphs with node labels, graphs with edge attributes or graphs with additional attributes at the graph level.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description, it will be evident to a person skilled in the art that various modifications may be made within the scope of the invention.

What is claimed is:

1. A data processing system for implementing a machine learning process in dependence on a graph neural network, the system comprises at least one processor, the processor being configured to receive a plurality of input graphs each having a plurality of nodes, at least some of the nodes having an attribute, the processor being configured to:
for at least one graph of the input graphs:
determine one or more sets of nodes of the plurality of nodes, the nodes of each set having identical attributes;
for each set, assign a label to each of the nodes of that set so that each node of a set has a different label from the other nodes of that set;
process the sets to form an aggregate value; and
implement the machine learning process taking as input: (i) the input graphs with the exception of the said sets and (ii) the aggregate value.

2. The system of claim 1, wherein the processor is configured to process each set to form an aggregate value by processing neighbour nodes of each node of that set using a permutation invariant function.

3. The system of claim 2, wherein the permutation invariant function is one of a sum, a mean, or a maximum.

4. The system of claim 1, wherein the processor is configured to process the sets by assigning weights to the nodes, wherein the weights are the parameters of a neural network.

5. The system of claim 4, wherein the processor is further configured to iteratively update the weights.

6. The system of claim 1, wherein each attribute and/or label is a vector.

7. The system of claim 1, wherein each label is a colour.

8. The system of claim 1, wherein the labels are randomly assigned to the determined nodes.

9. A method for implementing a machine learning process in dependence on a graph neural network in a data processing system, the system being configured to receive a plurality of input graphs each having a plurality of nodes, at least some of the nodes having an attribute, the method comprising:
for at least one graph of the input graphs:
determining one or more sets of nodes of the plurality of nodes, the nodes of each set having identical attributes;
for each set, assigning a label to each of the nodes of that set so that each node of a set has a different label from the other nodes of that set;
processing the sets to form an aggregate value; and
implementing the machine learning process taking as input: (i) the input graphs with the exception of the said sets and (ii) the aggregate value.

10. The method of claim 9, wherein each set is processed to form an aggregate value by processing neighbour nodes of each node of that set using a permutation invariant function.

11. The method of claim 10, wherein the permutation invariant function is one of a sum, a mean, or a maximum.

12. The method of claim 9, wherein the system is configured to process the sets by assigning weights to the nodes, wherein the weights are the parameters of a neural network.

13. The method of claim 12, wherein the method further comprises iteratively updating the weights.

14. The method of claim 9, wherein each label is a colour.

15. The method of claim 9, wherein the labels are randomly assigned to the determined nodes.
